(19) United States
(12) Patent Application Publication
(10) Pub. No.: US 2022/0104174 A1
(43) Pub. Date: Mar. 31, 2022

(54) METHOD, DEVICE AND COMPUTER READABLE MEDIUM FOR PAGING IN NEW RADIO SYSTEMS

(71) Applicant: Nokia Technologies Oy, Espoo (FI)

(72) Inventors: Jianguo LIU, Shanghai (CN); Tao TAO, Shanghai (CN); Zhe LUO, Shanghai (CN); Yan MENG, Shanghai (CN); Gang SHEN, Shanghai (CN)

(21) Appl. No.: 17/418,084

(22) PCT Filed: Jan. 10, 2019
(86) PCT No.: PCT/CN2019/071232

§ 371 Date: Jun. 24, 2021

(51) Int. Cl. H04W 68/02; H04W 68/00; H04W 76/28

(52) U.S. Cl. CPC H04W 68/02; H04W 76/28; H04W 68/005

(57) ABSTRACT

Embodiments of the disclosure provide a method, device and computer readable medium for paging in new radio systems. According to embodiments of the present disclosure, the network device transmits an indication to multiple terminal devices to indicate whether the paging overload occurs on the PO. The terminal device determines whether to continue monitoring the paging message based on the indication. In this way, the power consumption is reduced.

### FIELD

Embodiments of the present disclosure generally relate to communication techniques, and more particularly, to methods, devices and computer readable medium for paging in new radio systems.

### BACKGROUND

In recent years, different communication technologies have been proposed to improve communication performances, such as, the New Radio (NR) system. In NR, the terminal devices are configured to use Discontinuous Reception (DRX) to reduce power consumption and the terminal devices are expected to monitor one paging occasion (PO) per DRX cycle. In NR-based access to unlicensed spectrum (NR-U), the paging message transmission should comply with the unlicensed band regulation. Further studies on paging for NR especially for NR-U are still needed.

### SUMMARY

Generally, embodiments of the present disclosure relate to a method for paging in NR and the corresponding communication devices.

In a first aspect, embodiments of the disclosure provide an apparatus. The apparatus comprises: at least on processor; and a memory coupled to the at least one processor, the memory storing instructions therein, the instructions, when executed by the at least one processor, causing the apparatus to: transmit, to a terminal device, configuration information for configuring one or more paging occasions to the terminal device in a discontinuous reception (DRX) cycle, the one or more paging occasions being used for monitoring paging messages. The network device is further caused to determine whether a channel is available on one paging occasion from the paging occasions on which paging messages are to be transmitted. The network device is also caused to in response to a determination that the channel is available on the paging occasion, generate an indication as to whether a paging overload occurs on the paging occasion. The network device is also caused to transmit the generated indication to the terminal devices.

In a second aspect, embodiments of the disclosure provide an apparatus. The apparatus comprises: at least on processor; and a memory coupled to the at least one processor, the memory storing instructions therein, the instructions, when executed by the at least one processor, causing the apparatus to: receive, from a network device, configuration information for configuring one or more paging occasions to a terminal device in a discontinuous reception (DRX) cycle. The terminal device is also caused to monitor a paging message related to the terminal device on a paging occasion from the one or more paging occasions. The terminal device is further caused to receive an indication indicating whether a paging overload occurs on the paging occasion for facilitating receiving the paging message.

In a third aspect, embodiments of the present disclosure provide a method. The method comprises: transmitting, to a terminal device, configuration information for configuring one or more paging occasions to the terminal device in per discontinuous reception (DRX) cycle. The one or more paging occasions is used for monitoring paging messages. The method also comprise determining whether a channel is available on one paging occasion from the paging occasions on which paging messages are to be transmitted. The method further comprises in response to a determination that the channel is available on the paging occasion, generating an indication as to whether a paging overload occurs on the paging occasion. The method also comprises transmitting the generated indication to the terminal devices.

In a fourth aspect, embodiments of the present disclosure provide a method. The method comprises: receiving, from a network device, configuration information for configuring one or more paging occasions to a terminal device in a discontinuous reception (DRX) cycle. The method also comprises monitoring a paging message related to the terminal device on a paging occasion from the one or more paging occasions. The method further comprises receiving an indication indicating whether a paging overload occurs on the paging occasion for facilitating receiving the paging message.

In a fifth aspect, embodiments of the disclosure provide an apparatus for communication. The apparatus comprises: means for transmitting, to a terminal device, configuration information for configuring one or more paging occasions to the terminal device in a discontinuous reception (DRX) cycle, the one or more paging occasions being used for monitoring paging messages. The apparatus further comprises means for determining whether a channel is available on one paging occasion from the paging occasions on which paging messages are to be transmitted. The apparatus also comprises means for in response to a determination that the channel is available on the paging occasion, generating an indication as to whether a paging overload occurs on the paging occasion. The apparatus further comprises means for transmitting the generated indication to the terminal devices.

In a sixth aspect, embodiments of the disclosure provide an apparatus for communication. The apparatus comprises: means for receiving, from a network device, configuration information for configuring one or more paging occasions to a terminal device in a discontinuous reception (DRX) cycle. The apparatus also comprises means for monitoring a paging message related to the terminal device on a paging occasion from the one or more paging occasions. The apparatus further comprises means for receiving an indication indicating whether a paging overload occurs on the paging occasion for facilitating receiving the paging message.

In a seventh aspect, embodiments of the disclosure provide a computer readable medium. The computer readable medium stores instructions thereon, the instructions, when executed by at least one processing unit of a machine, causing the machine to implement the methods according to the third and fourth aspects.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates a schematic diagram of a communication system according to embodiments of the present disclosure;

FIG. 2 illustrates a flow chart of a method implemented at a communication device according to embodiments of the present disclosure;

FIG. 3 illustrates a schematic diagram of allocation of paging occasions of according to embodiments of the present disclosure;

FIG. 4 illustrate a schematic diagrams of paging transmission according to embodiments of the present disclosure;

FIG. 5 illustrates a schematic diagrams of paging transmission according to embodiments of the present disclosure;

FIG. 6 illustrates a flow chart of a method implemented at a communication device according to embodiments of the present disclosure; and

FIG. 7 illustrates a schematic diagram of a device according to embodiments of the present disclosure.

Throughout the figures, same or similar reference numbers indicate same or similar elements.

### DETAILED DESCRIPTION OF EMBODIMENTS

The subject matter described herein will now be discussed with reference to several example embodiments. It should be understood these embodiments are discussed only for the purpose of enabling those skilled persons in the art to better understand and thus implement the subject matter described herein, rather than suggesting any limitations on the scope of the subject matter.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two functions or acts shown in succession may in fact be executed concurrently or may sometimes be executed in the reverse order, depending upon the functionality/acts involved.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future.

Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system. For the purpose of illustrations, embodiments of the present disclosure will be described with reference to 5G communication system.

The term “network device” used herein includes, but not limited to, a base station (BS), a gateway, a registration management entity, and other suitable device in a communication system. The term “base station” or “BS” represents a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth.

The term “terminal device” used herein includes, but not limited to, “user equipment (UE)” and other suitable end device capable of communicating with the network device. By way of example, the “terminal device” may refer to a terminal, a Mobile Terminal (MT), a Subscriber Station (SS), a Portable Subscriber Station, a Mobile Station (MS), or an Access Terminal (AT).

The term “circuitry” used herein may refer to one or more or all of the following:

(a) hardware-only circuit implementations (such as implementations in only analog and/or digital circuitry) and

(b) combinations of hardware circuits and software, such as (as applicable):

(i) a combination of analog and/or digital hardware circuit(s) with

software/firmware and

(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As mentioned above, in NR, the terminal is configured to use DRX to reduce power consumption. The terminal device is expected to monitor one paging occasion (PO) per DRX cycle. The term “paging occasion” used herein refers to a set of control channel (for example, physical downlink control channel (PDCCH)) monitoring occasions and may consist of multiple time slots (for example, subframe or OFDM symbol) where downlink control information (DCI) regarding paging can be sent. One Paging Frame (PF) is one Radio Frame and may contain one or multiple PO(s) or starting point of a PO.

In multi-beam operations, the length of one PO is one period of beam sweeping and the terminal device can assume that the same paging message is repeated in all beams of the sweeping pattern and thus the selection of the beam(s) for the reception of the paging message is up to terminal device implementation. The paging message is same for both radio access network (RAN) initiated paging and core network (CN) initiated paging.

In NR-U, the paging message transmission should be applied with the unlicensed band regulation, for example, listen-before-talk (LBT) in 5 GHz unlicensed band. It means the channel is not always available for the network device to transmit the paging message for a terminal device in a configured PO. From the terminal device perspective, it may or may not receive the paging message in the PO from the network, meanwhile it's not aware of whether it's not paged or the channel is not available. If the paging is blocked by the LBT, it has to be postponed to the next cycle when the channel is available. However, it's not acceptable for the usage of paging given that if the paging is used for some latency critical service. It should be noted that the default paging cycle can be up to 256 radio frames which is too much latency. Thus, it is necessary to increase available opportunities for paging transmission for NR-U operation.

Regarding the above issues, the following agreement has been reached: modifications to paging procedures due to reduced transmission opportunities for paging due to LBT failure are beneficial and should be identified and studied. Furthermore, the following agreement has also been reached: agree to allow more paging transmission opportunities per DRX cycle for a terminal device in NR-U.

Currently, designs of allocation scheme for additional POs for DRX UE within one DRX cycle have been studied. In the time domain, there are some alternatives to increase the paging transmission opportunities per DRX cycle for a terminal device: Option I: Extended PO window, which means if the network device cannot send out the paging successfully during the PO window in the calculated PO, it keeps trying to transmit paging within the extended PO window; Option II: Additional PO, which means if the network device cannot send out the paging successfully during the PO window in the first calculated PO per DRX cycle, it tries to transmit paging in the next multiple POs.

However, for option I, the network device shall try not to include the uplink (UL) slots/symbols in the PO window as the terminal device cannot distinguish between the case where there are UL slots/symbols and the case where no paging received due to LBT failure. Otherwise, the power consumption of the terminal device may increase because the terminal device may monitor the extended longer window due to presence of UL transmission.

Moreover, the extended monitoring window would be consisted of consecutive time slot. If once the LBT is failed, the following LBT is likely failed in a short time. So, the possibility of LBT failure of the Option I would be high.

For option II, the network is able to try to access the resource at next PO in case of LBT failure. So, the power consumption would be less than extended monitoring window as the terminal device isn't required to keep monitoring paging transmission in an extended longer window. In addition, the additional PO can have time distance between determined PO and additional PO. Thus, the possibility of LBT failure is lower than extended monitoring window.

However, as discussed above, more paging occasions per DRX cycle for a terminal device would be beneficial in NR-U in consideration of the possibility that the paging message from the network device is blocked by LBT on the unlicensed band. It means the terminal device should wake up longer time to monitor paging transmission in the candidate paging occasions, thereby leading to more power consumption at the terminal device.

In terms of power saving for DRX UE, it may be possible to stop monitoring paging message when the transmission of paging message is detected in one of calculated POs. However, as the number of required POs per terminal device increases, it's beneficial to multiplex more terminal devices in the same PO so as to increase the resources for data transmission and make configuration of UL slots/symbols and additional paging occasions easier. For example, an option of additional PO design is to reuse the existing POs taking the PO/PF calculation in NR as the baseline for NR-U. When part of or all of POs are blocked, the blocked paging message might be transmitted at the next existing PO if LBT succeeds. In this case, the terminal device needs keep monitoring the next PO which is based on PDCCH configuration for paging.

In some situations, multiple terminal devices are configured to receive the paging message in the same paging occasion. A lot of pending paging messages may be accumulated from the previous blocked POs due to LBT failure which could lead to paging overload (that is, high load) in the available PO where LBT succeeds. Due to paging overload, the network device cannot transmit the pending messages from one of the available POs to all the paged terminal devices. As the terminal device cannot distinguish whether the paging messages are overloaded in the available PO, the terminal device may be hard to decide whether it should continue monitoring the Paging Radio Network Temporary Identity (P-RNTI) after the transmission of paging message for the terminal device is detected but without its corresponding UE ID in the UE identify fields of the paging message.

On one hand, if the terminal device stops monitoring P-RNTI until the next DRX cycle for power saving, the pending message for this UE may be discarded due to paging overload. On the other hand, extra power consumption may be caused if the terminal device continues monitoring P-RNTI in other configured POs whilst there is no corresponding paging message (that is, paging overload doesn't happen).

Therefore, new mechanism is required in NR-U to reduce power consumption for monitoring paging transmission in multiple configured POs taking the paging overload problem into consideration. According to embodiments of the present disclosure, the network device transmits an indication to multiple terminal devices to indicate whether the paging overload occurs on the PO. The terminal device determines whether to continue monitoring the paging message based on the indication. In this way, the power consumption is reduced. In addition, transmission resources are saved and flexible configuration of UL subframes and PO is achieved.

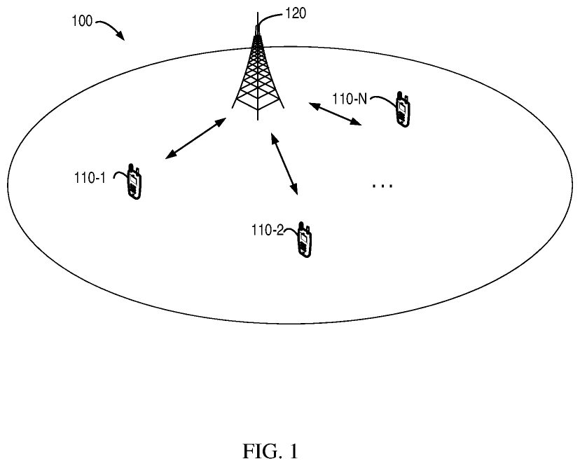

FIG. 1 illustrates a schematic diagram of a communication system 100 in which embodiments of the present disclosure can be implemented. The communication system 100, which is a part of a communication network, comprises terminal devices 110-1, 110-2, . . . , 110-N (collectively referred to as “terminal device(s) 110” where N is an integer number) and a network device 120. It should be noted that the communication system 100 may also comprise other elements which are omitted for the purpose of clarity. The network device 120 may communicate with the terminal devices 110. It is to be understood that the numbers of terminal devices and network devices shown in FIG. 1 are given for the purpose of illustration without suggesting any limitations. The communication system 100 may include any suitable number of network devices and terminal devices.

Communications in the communication system 100 may be implemented according to any proper communication protocol(s), including, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, including but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

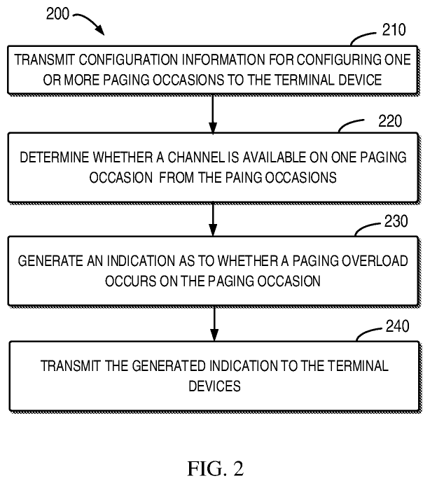

FIG. 2 illustrates a flow chart of a method 200 in accordance with embodiments of the present disclosure. The method 200 may be implemented at any suitable apparatus. Only for the purpose of illustrations, the method 200 is described to be implemented at the network device 120.

At block 210, the network device 120 transmits configuration information for configuring one or more occasions to the terminal device (for example, the terminal device 110-1). The one or more paging occasions are used for monitoring paging messages. In this way, multiplexing a large of terminal devices over a single PO in NR-U is achieved, thereby reducing transmission resources of multiple POs per DRX cycle for a terminal device and enabling flexible configuration of UL subframes and PO in NR-U.

In some embodiments, the configuration information may comprise one of: a discontinuous reception (DRX) cycle (T), the number of paging frames on one DRX cycle (N), the number of paging occasions for one paging frame (Ns), the number of paging occasions per terminal device in one DRX cycle (MPO), or offset used for paging fame determination (PF_offset) or their proper combinations. The configuration information may be signaled in system information block, for example, N, Ns, first-PDCCH-MonitoringOccasionOfPO, PF_offset. In other embodiments, the configuration information may be transmitted via a radio resource control (RRC) signaling. For example, the parameters T and MPO may be configured via the RRC signaling. Alternatively, the configuration information may be configured via an upper layer signaling. In other embodiments, the configuration information may also be a default value broadcast in system information. In some embodiments, the configuration information may comprise the number of groups at one paging occasion. For example, the configuration information may comprise that there are 3 groups of terminal devices at the PO 310-4.

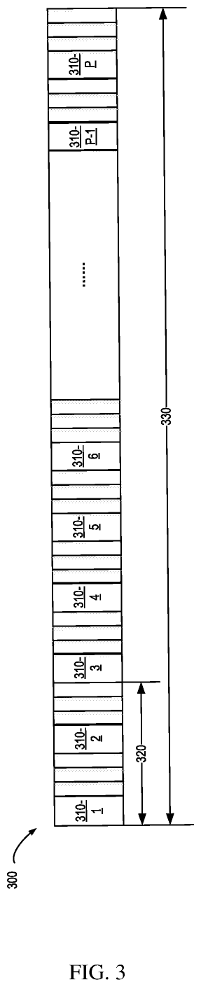

FIG. 3 illustrates a schematic diagram of allocation 300 of multiple UE-specific POs per DRX cycle according to embodiments of the present disclosure. As shown in FIG. 3, there are a plurality of paging occasions 310-1, 310-2, 310-3, 310-4, 310-5, 310-6, . . . , 310-P−1 and 310-P (collectively referred to as “PO 310”, where P is a suitable integer number). As shown in FIG. 3, the length of the DRX cycle 330 is 320 ms (that is, T=320) and there are 32 paging frames in a DRX cycle (that is, N=32) with 2 paging occasions 310-1 and 310-2 (that is, Ns=2). In the case that MPO=6, 6 adjacent existing POs in NR will be allocated for the terminal device to monitor paging transmission in a DRX cycle.

Referring back to FIG. 2. At block 220, the network device 120 determines whether a channel is available on one paging occasions from the configured paging occasions. In some embodiments, the network device 120 may try to grab channel for paging transmission at the configured POs.

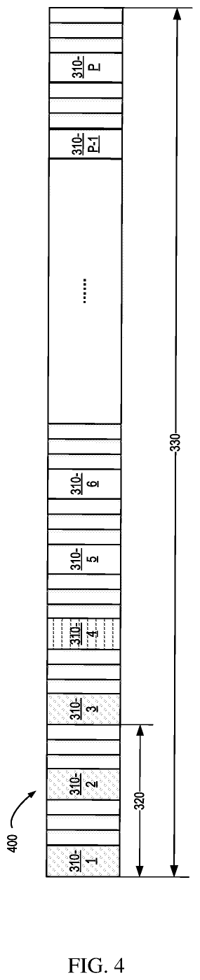

FIG. 4 illustrates a schematic diagram of paging transmission 400 according to embodiments of the present disclosure. As shown in FIG. 4, the network device may determine whether a channel is available on the configured POs. For example, the network device 120 may fail in LBT on the POs 310-1, 310-2 and 310-3. In this case, the transmission of paging messages may be blocked at the POs 310-1, 310-2 and 310-3 and thus terminal device will not be able to detect the paging radio network tempory identity (P-RNTI) at the configured PO. In this case, the network device 120 would continue to transmit the blocked paging messages from previous POs at the next PO and the terminal devices 110 shall keep monitoring paging transmission at the next configured PO.

As shown in FIG. 4, the channel is available on PO 310-4. In this case, since the blocked paging message towards the terminal devices 110 will be scheduled to transmit at the next available UE-specific PO of the terminal devices 110, the paging messages in POs 310-1, 310-2 and 310-3 may also be transmitted on the PO 310-4.

Referring back to FIG. 2. At block 230, the network device 120 generates an indication to indicate whether the paging overload occurs on the paging occasion (for example, PO 310-4). The paging overload may occur due to limitation of paging recorders or paging payload.

By way of example, the indication may be 1-bit information which is carried in the signaling to indicate whether there are terminal devices which have pending paging transmission and cannot be paged at the available PO due to paging overload. For example, 0 could be used to indicate the paging message without overload at the available configured PO, and 1 could be used to indicate the paging overload.

In some embodiments, the DRX terminal devices which are configured to monitor paging messages at an available PO may be grouped according to certain metric. For an example, the terminal devices may be grouped based on the number/index of the UE-specific POs. In this case, 1-bit information per group can be carried in the signaling to indicate whether there are UEs in the corresponding group which have pending paging transmission and cannot be paged at the available PO due to paging overload.

By way of example, 0 could be used to indicate that there are no pending messages for a given grouped terminal devices, and 1 could be used to indicate that not all the pending messages are transmitted for a given group UEs. For example, assume that three group of terminal devices are configured to monitor the paging transmission on one PO. Due to paging overload, some of terminal devices in the 3rd group cannot be paged in the available configured PO. In this case, 3-bit information (for example, 001) can be used to indicate the paging load status for all the DRX terminal devices which are configured to monitor the paging information in the corresponding PO. Specifically, the “001” indicates that there is no paging overload for the first and second groups of terminal devices and there is a paging overload for the third group of terminal devices.

In some embodiments, the network device 120 may compare the number of paging recorders in paging messages with a predetermined number. The paging message may have more than one paging recorder and one paging recorder corresponds to a terminal device. If the number of the paging message is below the predetermined number, the network device 120 may generate the indication to indicate that there is no paging overload on the PO 310-4. If the number of the paging message exceeds the predetermined number, the network device 120 may generate the indication to indicate that there is a paging overload on the PO 310-4.

Alternatively, the network device 120 may compare the payload size of the paging message with transport block size (TBS) of a downlink channel. If the payload size is below the TBS, the network device 120 may generate the indication to indicate that there is no paging overload on the PO 310-4. If the payload size exceeds the TBS, the network device 120 may generate the indication to indicate that a paging overload on the PO 310-4.

In some embodiments, if no paging overload occurs, the network device 120 may transmit the pending paging message with an indication of no paging overload to all the terminal devices which are configured with UE-specific PO at this PO.

If the terminal devices are not grouped, a common indication with 1-bit information may be used to signal the paging load status. Alternatively, the network device 120 may generate the indication to indicate that whether the paging overload occurs for each group. For example, 1-bit information may be used for each group of terminal devices to signal the paging load status for the corresponding grouped terminal devices.

If the paging overload occurs at the PO, the network device 120 may transmit the paging message with a paging load indication to the terminal devices which are configured with UE-specific PO at this PO.

If the terminal devices are not grouped, a common indication with 1-bit information may be used to signal the paging load status. Alternatively, if the terminal device 110-1 is grouped and the indication may state that the paging overload occurs, the network device 120 may determine whether the paging overload for the group of terminal devices to which the terminal device 110-1 belong. For example, if there are multiple terminal devices in this group and the network device 120 determines that at least one paging recorder belonging to the group of terminal devices can't be delivered, the network device 120 may generate the indication to indicate that the paging overload occurs for this group of terminal devices.

The network device 120 may generate the indication to indicate whether the paging overload for the group of terminal devices to which the terminal device 110-1 belong. For example, 1-bit information may be used for each group of terminal devices to signal the paging load status for the corresponding grouped terminal devices.

At block 240, the network device 120 transmits the generated indication to one or more terminal devices 110. In some embodiments, the indication may be transmitted in downlink control information of the paging message. Alternatively, the indication may be transmitted as a part of the paging message.

In some embodiments, if no paging overload occurs, after transmission of paging message at this PO, the network device 120 may not transmit the paging message again to these terminal devices until next DRX cycle. In other embodiments, if the paging overload occurs, after transmission of paging message, the network device 120 may not transmit UE-specific paging message to the terminal devices, which UE IDs are encrypted in the UE identify fields of the paging message or are explicitly indicated that there are no pending paging messages in their corresponding groups, until next DRX cycle. However, the remained paging message may be transmitted by the network device 120 at next available PO due to paging overload.

In some embodiments, an apparatus for performing the method 200 (for example, the network device 120-1) may comprise respective means for performing the corresponding steps in the method 200. These means may be implemented in any suitable manners. For example, it can be implemented by circuitry or software modules.

In some embodiments, the apparatus comprises: means for transmitting, to a terminal device, configuration information for configuring one or more paging occasions to the terminal device in a DRX cycle, the one or more paging occasions being used for monitoring paging messages; means for determining whether a channel is available on one paging occasion from the paging occasions on which paging messages are to be transmitted; means for in response to a determination that the channel is available on the paging occasion, generating an indication as to whether a paging overload occurs on the paging occasion; and means for transmitting the generated indication to the terminal devices.

In some embodiments, the configuration information comprises at least one of: the discontinuous reception (DRX) cycle, the number of paging frames on one DRX cycle, the number of paging occasions for one paging frame, and the number of paging occasions per terminal device in one DRX cycle.

In some embodiments, the configuration information is transmitted in system information or via a Radio Resource Control (RRC) signaling.

In some embodiments, the means for generating the indication comprises means for comparing the number of paging recorders in the paging message with a threshold number; and means for in response to the number of the paging recorders being below the threshold number, generating the indication that no paging overload occurs.

In some embodiments, the means for generating the indication: means for comparing a payload size of the paging message with transport block size (TBS) of a downlink channel; and means for in response to the payload size of the paging message being below the TBS, generating the indication that no paging overload occurs.

In some embodiments, the means for generating the indication comprises: means for comparing the number of paging recorders in the paging message with a threshold number; and means for in response to the number of the paging recorders exceeding the predetermined number, generating the indication that the paging overload occurs.

In some embodiments, the means for generating the indication comprises means for comparing a payload size of the paging message with a transport block size (TBS) of a downlink channel; and means for in response to the payload size of the paging message exceeding the TBS, generating the indication that the paging overload occurs.

In some embodiments, the indication is transmitted in the paging message. In some embodiments, the indication is transmitted in downlink control information (DCI) of the paging message.

In some embodiments, the apparatus further comprises: means for in response to a determination that a paging overload occurs on a previous paging occasion, transmitting one or more paging messages left from the previous paging occasion on the paging occasion.

In some embodiments, the means for generating the indication further comprises: means for generating the indication as to whether a paging overload occurs on the paging occasion for the group of terminal devices, the terminal device belonging to the group of terminal devices.

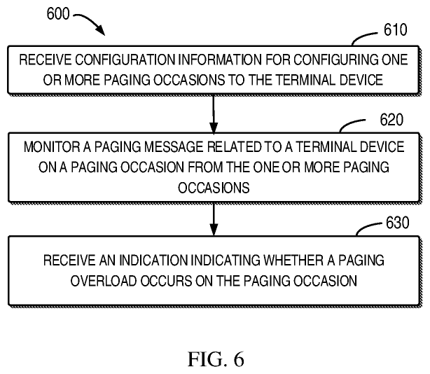

FIG. 6 illustrates a flow chart of a method 600 in accordance with embodiments of the present disclosure. The method 600 may be implemented at any suitable apparatus. Only for the purpose of illustrations, the method 300 is described to be implemented at the terminal device 110-1.

At block 610, the terminal device 110-1 receives configuration information for configuring one or more paging occasions to itself in a DRX cycle from the network device 120. In some the configuration information may comprise one of: a discontinuous reception (DRX) cycle (T) for the set of terminal devices, the number of paging frames on one DRX cycle (N), the number of paging occasions for one paging frame (Ns), the number of paging occasions per terminal device in one DRX cycle (MPO), or offset used for paging fame determination (PF_offset) or their proper combinations. The configuration information may be signaled in system information block, for example, N, Ns, first-PDCCH-MonitoringOccasionOfPO, PF_offset. In other embodiments, the configuration information may be transmitted via a radio resource control (RRC) signaling. For example, the parameters T and MPO may be configured via the RRC signaling. Alternatively, the configuration information may be configured via an upper layer signaling. In other embodiments, the configuration information may also be a default value broadcast in system information.

At block 620, the terminal device 110-1 monitors a paging message related to itself on one of the one or more paging occasions. For example, as shown in FIG. 3, the POs 310 are configured to the terminal device 110-1. The terminal device 110-1 may monitor the paging message on these POs.

At block 630, the terminal device 110-1 receives an indication from the network device 120. The indication indicates whether a paging overload occurs on the paging occasions. In this way, the terminal device is able to save energy and reduce power consumption.

In some embodiments, if the indication states that there is no paging overload on the PO, the terminal device 110-1 may stop monitoring the paging message. For example, as shown in FIG. 4, since the network device 120 fails LBT on the POs 310-1, 310-2, 310-3 and succeeds at the PO 310-4, the terminal device 110-1 may receive the indication on the PO 310-4. If the indication states that there is no paging overload on the PO 310-4, the terminal device 110-1 may blindly detect the paging message at the PO 310-4 and does not need to monitor the paging message until the end of the DRX cycle 330.

Alternatively, the indication may sate the paging overload occurs. In such situation, if the terminal device 110-1 receives UE-specific paging message in the PO or is informed through the indication signaling of paging load status that there are no pending messages in their corresponding groups, the terminal device 110-1 does not need to monitor the paging message until next DRX cycle. In an example embodiment, if the terminal device 110-1 is configured to monitor paging message at this PO, the terminal device 110-1 may be required to monitor paging message in its UE-specific POs.

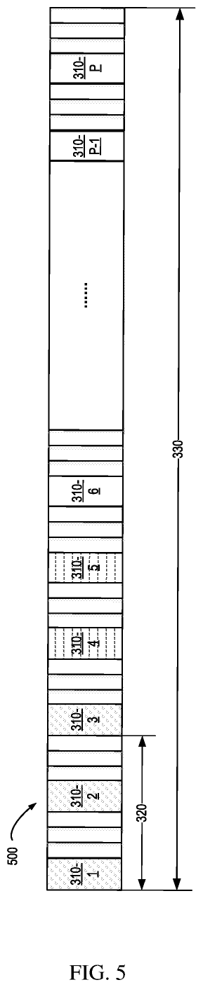

FIG. 5 illustrates a schematic diagram of paging transmission 500 according to embodiments of the present disclosure. As shown in FIG. 5, assume that two terminal devices 110-1 and 110-2 are configured to monitor paging message at respective UE-specific POs. The indication indicates that the paging overload happens in the PO 310-4. In this case, the terminal device 110-1 may stop monitoring paging message at other UE-specific POs until next DRX cycle as it has been paged in its UE-specific PO (for example, the PO 310-4), and the terminal device 110-2 may keep monitoring paging message at next UE-specific PO (for example, the PO 310-5) when its UE ID is not encrypted in the paging message and the paging overload is detected.

In other embodiments, the terminal devices 110 may be grouped based on the index of UE-specific POs in a DRX cycle and configuration of the grouping number of terminal devices at one paging occasion. Only as an example, assume that the grouping number of terminal devices is 6 at each paging occasion, the terminal device 110-1 and the terminal device 110-2 may be grouped into the 4th group and the 3rd group at the cell-specific PO of P4. The network device 110-1 may transmit 6-bit information (e.g. 001000) to terminal devices to indicate the paging load status per group. Based on the detection of paging load indication, each terminal device which is configured to monitor the paging transmission in the given PO may know whether the network device 120 pages all the terminal devices in its corresponding group. In this case, the terminal device 110-2 may keep monitoring paging message at next UE-specific PO (i.e. the PO 310-5) when its UE ID is not encrypted in the paging message and the paging overload is detected in the 3rd group while the terminal device 110-1 can stop monitoring paging message at their corresponding UE-specific POs until next DRX cycle as they have been paged in its UE-specific PO (i.e. the PO 310-4) or have received an indication of no paging overload in their corresponding groups.

In some embodiments, an apparatus for performing the method 600 (for example, the terminal device 110-1) may comprise respective means for performing the corresponding steps in the method 600. These means may be implemented in any suitable manners. For example, it can be implemented by circuitry or software modules.

In some embodiments, the apparatus comprises: means for receiving, from a network device, configuration information for configuring one or more paging occasions to a terminal device in a discontinuous reception (DRX) cycle; means for monitoring a paging message related to the terminal device on a paging occasion from the one or more paging occasions; and means for receiving an indication indicating whether a paging overload occurs on the paging occasion for facilitating receiving the paging message.

In some embodiments, the configuration information comprises at least one of: the discontinuous reception (DRX) cycle, the number of paging frames on one DRX cycle, the number of paging occasions for one paging frame, and the number of paging occasions per terminal device in one DRX cycle.

In some embodiments, the apparatus further comprises: means for in response to the indication indicating that no paging overload occurs, stopping monitoring the paging message related to the terminal device until next DRX cycle.

In some embodiments, the apparatus further comprises: means for in response to the indication indicating that the paging overload occurs and receiving the paging message related to the terminal device, stopping monitoring the paging message.

In some embodiments, the apparatus further comprises: means for in response to the indication indicating that the paging overload occurs and failing to receive a paging message related to the terminal device, keeping monitoring the paging message related to the terminal device.

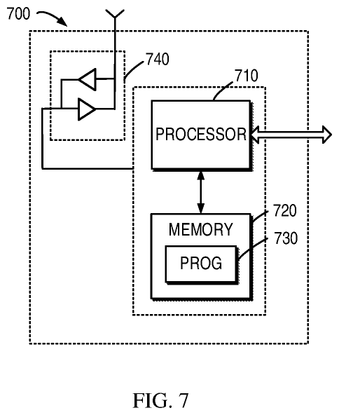

FIG. 7 is a simplified block diagram of a device 700 that is suitable for implementing embodiments of the present disclosure. The device 700 may be implemented at the registration management entity 730. The device 700 may also be implemented at the terminal device 110-1. The device 700 may also be implemented at the network device 120. As shown, the device 700 includes one or more processors 710, one or more memories 720 coupled to the processor(s) 710, one or more transmitters and/or receivers (TX/RX) 740 coupled to the processor 710.

The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples.

The memory 720 stores at least a part of a program 730. The TX/RX 540 is for bidirectional communications. The TX/RX 740 has at least one antenna to facilitate communication, though in practice an Access Node mentioned in this application may have several ones. The communication interface may represent any interface that is necessary for communication with other network elements.

The program 730 is assumed to include program instructions that, when executed by the associated processor 710, enable the device 700 to operate in accordance with the embodiments of the present disclosure, as discussed herein with reference to FIGS. 2 and 6. That is, embodiments of the present disclosure can be implemented by computer software executable by the processor 510 of the device 500, or by hardware, or by a combination of software and hardware.

While this specification contains many specific implementation details, these should not be construed as limitations on the scope of any disclosure or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications, adaptations to the foregoing exemplary embodiments of this disclosure may become apparent to those skilled in the relevant arts in view of the foregoing description, when read in conjunction with the accompanying drawings. Any and all modifications will still fall within the scope of the non-limiting and exemplary embodiments of this disclosure. Furthermore, other embodiments of the disclosures set forth herein will come to mind to one skilled in the art to which these embodiments of the disclosure pertain having the benefit of the teachings presented in the foregoing descriptions and the associated drawings.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purpose of limitation.

1.-36. (canceled)

37. An apparatus, comprising:
at least one processor; and
a memory coupled to the at least one processor, the memory storing instructions therein, the instructions, when executed by the at least one processor, causing the apparatus to:
transmit, to a terminal device, configuration information for configuring one or more paging occasions in a discontinuous reception cycle, the one or more paging occasions being used for monitoring paging messages;
generate an indication indicating whether the terminal device stops monitoring the paging messages during the one or more paging occasions; and
transmit the generated indication to the terminal device.

38. The apparatus of claim 37, wherein the configuration information comprises at least one of:
the discontinuous reception cycle,
a number of paging frames in one discontinuous reception cycle,
a number of paging occasions for one paging frame,
a number of paging occasions per terminal device in one discontinuous reception cycle,
an offset to determine a paging frame, and
a number of groups of terminal devices at one paging occasion.

39. The apparatus of claim 37, wherein generating the indication is according to a determination on whether a channel is available on one paging occasion from the one or more paging occasions on which the paging messages are to be transmitted.

40. The apparatus of claim 37, wherein the configuration information is transmitted in a system information or via a radio resource control signaling.

41. The apparatus of claim 37, wherein the apparatus is caused to generate the indication by:
comparing a number of paging recorders in the paging message with a threshold number; and
in response to the number of the paging recorders being below a threshold number, generating the indication that the terminal device keeps monitoring the paging message during the one or more paging occasion.

42. The apparatus of claim 37, wherein the apparatus is caused to generate the indication by:
comparing a payload size of the paging message with a transport block size (TBS) of a downlink channel; and
in response to the payload size of the paging message being below the TBS, generating the indication that the terminal device keeps monitoring the paging message during the one or more paging occasion.

43. The apparatus of claim 37, wherein the apparatus is caused to generate the indication by:
comparing a number of paging recorders in the paging message with a threshold number; and
in response to the number of the paging recorders exceeding the threshold number, generating the indication that the terminal device stops monitoring the paging message during the one or more paging occasion.

44. The apparatus of claim 37, wherein the apparatus is caused to generate the indication by:
comparing a payload size of the paging message with a transport block size (TBS) of a downlink channel; and
in response to the payload size of the paging message exceeding the TBS, generating the indication that the terminal device stops monitoring the paging message during the one or more paging occasion.

45. The apparatus of claim 37, wherein the indication is a 1-bit information.

46. The apparatus of claim 37, wherein the indication is transmitted in downlink control information of the paging message.

47. The apparatus of claim 37, wherein the apparatus is caused to generate the indication by:
generating the indication as to whether indicating whether the terminal device stops monitoring the paging message during the one or more paging occasion for a group of terminal devices, the terminal device belonging to the group of terminal devices.

48. An apparatus, comprising:
at least one processor; and
a memory coupled to the at least one processor, the memory storing instructions therein, the instructions, when executed by the at least one processor, causing the apparatus to:
receive, from a network device, configuration information for configuring one or more paging occasions to a terminal device in a discontinuous reception cycle;
monitor a paging message related to the apparatus on a paging occasion from the one or more paging occasions; and
receive an indication indicating whether the apparatus stops monitoring the paging message during the paging occasion.

49. The apparatus of claim 48, wherein the configuration information comprises at least one of:
the discontinuous reception cycle,
a number of paging frames on one discontinuous reception cycle,
a number of paging occasions for one paging frame,
a number of paging occasions per terminal device in one discontinuous reception cycle,
an offset to determine a paging frame, and
the number of groups of terminal devices at one paging occasion.

50. The apparatus of claim 48, wherein the configuration information is received in a system information or via a radio resource control signaling.

51. The apparatus of claim 48, wherein the indication is received in a downlink control information of the paging message.

52. The apparatus of claim 48, wherein the indication is a 1-bit information.

53. A method, comprising:
receiving, from a network device, configuration information for configuring one or more paging occasions to a terminal device in a discontinuous reception cycle;
monitoring a paging message related to the terminal device on a paging occasion from the one or more paging occasions; and
receiving an indication indicating whether the apparatus stops monitoring the paging message during the paging occasion.

54. The method of claim 53, wherein the configuration information comprises at least one of:
the discontinuous reception cycle,
a number of paging frames on one discontinuous reception cycle,
a number of paging occasions for one paging frame,
ae number of paging occasions per terminal device in one discontinuous reception cycle,
an offset to determine a paging frame, and
the number of groups of terminal devices at one paging occasion.

55. The method of claim 53, wherein the configuration information is received in a system information or via a radio resource control signaling.

56. The method of claim 53, wherein the indication is received in a downlink control information of the paging message.
